(19) United States
(12) Patent Application Publication
(10) Pub. No.: US 2021/0380908 A1
(43) Pub. Date: Dec. 9, 2021

(54) METHOD FOR PRODUCING POWDER LAUNDRY DETERGENT

(71) Applicants: Rohm and Haas Company, Collegeville, PA (US); Dow Brasil Sudeste Industrial Ltda., Sao Paulo/Sp (BR)

(72) Inventors: Laercio De Albuquerque, Cubatao (BR); Robert Butterick, Swedesboro, NJ (US); Mahesh R. Sawant, Chester, PA (US); Afua Sarpong Karikari, Bristol, PA (US)

(21) Appl. No.: 16/975,313

(22) PCT Filed: Mar. 21, 2019
(86) PCT No.: PCT/US2019/023296

§ 371 Date: Aug. 24, 2020

Related U.S. Application Data
(60) Provisional application No. 62/655,270, filed on Apr. 10, 2018.

(51) Int. Cl. C11D 11/02; C11D 3/37

(52) U.S. Cl. CPC C11D 11/02; C11D 3/3769

(57) ABSTRACT

A method for producing a powder detergent; said method comprising steps of: (a) combining (i) a polymer comprising polymerized units of at least one nitrogen-containing ethylenically unsaturated monomer having at least one pKa value from 6 to 11.5 and at least one ethylenically unsaturated carboxylic acid monomer, (ii) at least one surfactant, (iii) inorganic salts and (iv) water to form a slurry; wherein the slurry has a solids content from 50 to 90 wt %; and (b) spray drying the slurry to form a powder detergent.

### BACKGROUND

This invention relates generally to a method for producing a powder laundry detergent composition.

Powder laundry detergent is made by spray drying a concentrated slurry to produce a powder. The detergent slurry composition, also known as a crutcher slurry, is typically a high viscosity non-Newtonian mixture containing a high percentage of suspended solids. For spray drying a detergent slurry it is advantageous to have as high a solids content in the crutcher slurry as can be feasibly handled to improve productivity. However, the solids concentration has a direct impact on the slurry viscosity and is usually limited by the maximum viscosity that the spray nozzles can effectively atomize. Hydrophilic polymers have been added for this purpose, for example in U.S. Pat. No. 5,618,782. However, improved additives would be useful.

### STATEMENT OF INVENTION

The present invention is directed to a method for producing a powder detergent; said method comprising steps of: (a) combining (i) a polymer comprising polymerized units of at least one nitrogen-containing ethylenically unsaturated monomer having at least one pKa value from 6 to 11.5 and at least one ethylenically unsaturated carboxylic acid monomer, (ii) at least one surfactant, (iii) inorganic salts and (iv) water to form a slurry; wherein the slurry has a solids content from 50 to 90 wt %; and (b) spray drying the slurry to form a powder detergent.

### DETAILED DESCRIPTION

All percentages are weight percentages (wt %), and all temperatures are in ° C., unless otherwise indicated. Weight average molecular weights, M_{w}, are measured by gel permeation chromatography (GPC) using polyacrylic acid standards, as is known in the art. The techniques of GPC are discussed in detail in Modern Size Exclusion Chromatography, W. W. Yau, J. J. Kirkland, D. D. Bly; Wiley-Interscience, 1979, and in A Guide to Materials Characterization and Chemical Analysis, J. P. Sibilia; VCH, 1988, p. 81-84. The molecular weights reported herein are in units of daltons. As used herein the term “(meth)acrylic” refers to acrylic or methacrylic; the term “carbonate” to alkali metal or ammonium salts of carbonate, bicarbonate or sesquicarbonate; the term “and the term “citrate” to alkali metal citrates. Percentages of monomer units in the polymer are percentages of solids weight, i.e., excluding any water present in a polymer emulsion. All references to polymerized carboxylic acid units in the polymers include metal salts of the acid which would be present at pH values near or above the pKa of the carboxylic acid groups. pKa values are measured at 25° C. pKa for an amine refers to the pKa of the protonated amine.

Preferably, the slurry has a solids content of at least 50 wt %, preferably at least 55 wt %, preferably at least 60 wt %, preferably at least 65 wt %, preferably at least 70 wt %; preferably no more than 85 wt %, preferably no more than 82 wt %, preferably no more than 79 wt %, preferably no more than 76 wt %.

Preferably, an ethylenically unsaturated carboxylic acid monomer is a C₃-C₈ monoethylenically unsaturated carboxylic acid monomer, preferably C₃-C₄. Preferably, a carboxylic acid monomer has at least one carboxyl group attached to a carbon of a carbon-carbon double bond. Preferably, carboxylic acid monomers have one or two carboxyl groups, preferably one. Preferably, monoethylenically unsaturated carboxylic acid monomers are (meth)acrylic acids.

Preferably, a nitrogen-containing ethylenically unsaturated monomer has at least one pKa value of at least 6.5, preferably at least 7, preferably at least 7.5, preferably at least 8; preferably no greater than 11, preferably no greater than 10.5. Preferably, a nitrogen-containing ethylenically unsaturated monomer is monoethylenically unsaturated Preferably, a nitrogen-containing ethylenically unsaturated monomer comprises a substituted or unsubstituted amino group, preferably a tertiary amino group, preferably a tertiary aminoalkyl group, preferably a dialkylamino alkyl group, preferably a di-(C₁-C₆ alkyl)aminoalkyl group, preferably a di-(C₁-C₄ alkyl)aminoalkyl group, preferably a dimethylaminoalkyl or diethylaminoalkyl group, preferably a dimethylaminoalkyl group. Preferably, a tertiary aminoalkyl group comprises from 3 to 20 carbon atoms; preferably at least 4 carbon atoms; preferably no more than 15 carbon atoms, preferably no more than 10, preferably no more than 8. Preferably, a nitrogen-containing ethylenically unsaturated monomer is a substituted aminoalkyl ester or amide of (meth)acrylic acid, preferably a di-(C₁-C₄ alkyl)aminoethyl or di-(C₁-C₄ alkyl)aminopropyl ester or amide, preferably a di-(C₁-C₂ alkyl)aminoethyl or di-(C₁-C₂ alkyl)aminopropyl ester or amide, preferably 2-(dimethylamino)ethyl methacrylate or N-[3-(dimethylamino)propyl]methacrylamide.

Preferably, the polymer comprises polymerized units of from 5 to 40 wt % of at least one nitrogen-containing ethylenically unsaturated monomer and from 60 to 95 wt % of at least one ethylenically unsaturated carboxylic acid monomer. Preferably, the polymer comprises at least 7 wt % polymerized units of at least one nitrogen-containing ethylenically unsaturated monomer; preferably no more than 35 wt %, preferably no more than 30 wt %, preferably no more than 25 wt %, preferably no more than 20 wt %, preferably no more than 15 wt %. Preferably, the polymer comprises at least 65 wt % polymerized units of at least one ethylenically unsaturated carboxylic acid monomer, preferably at least 70 wt %, preferably at least 75 wt %, preferably at least 80 wt %, preferably at least 85 wt %.

Preferably, the slurry comprises from 0.1 to 5 wt % of the polymer, preferably at least 0.3 wt %, preferably at least 0.5 wt %, preferably at least 0.7 wt %, preferably at least 1.0 wt %; preferably no more than 3 wt %, preferably no more than 2 wt %, preferably no more than 1.5 wt %.

Preferably, inorganic salts include silicates, disilicates, aluminosilicates, sulfates, carbonates, bicarbonates, citrates, phosphates, tartrates, succinates, gluconates, and polycarboxylates. Preferably, inorganic salts comprise cations of metallic elements in Group 1, Group 2 or a combination thereof. Preferably, the inorganic salts are sodium, potassium or lithium salts; preferably sodium or potassium; preferably sodium. Preferably, the amount of inorganic salts in the slurry is from 50 to 90 wt %; preferably at least 55 wt %, preferably at least 60 wt %, preferably at least 65 wt %; preferably no more than 85 wt %, preferably no more than 80 wt %, preferably no more than 75 wt %. Preferably, the amount of sulfate (calculated from the weight of the entire sulfate salt) is from 20 to 70 wt %; preferably at least 25 wt %, preferably at least 30 wt %, preferably at least 35 wt %; preferably no more than 65 wt %, preferably no more than 60 wt %, preferably no more than 55 wt %, preferably no more than 50 wt %. Preferably, the amount of silicate (calculated from the weight of the entire silicate salt) is from 5 to 35 wt %; preferably at least 10 wt %, preferably at least 15 wt %; preferably no more than 30 wt %, preferably no more than 27 wt %. Preferably, the amount of carbonate (calculated from the weight of the entire carbonate salt) is no more than 25 wt %, preferably no more than 20 wt %, preferably no more than 15 wt %, preferably no more than 10 wt %.

Preferably, the slurry comprises from 10 to 50 wt % of water; preferably at least 15 wt %, preferably at least 18 wt %, preferably at least 21 wt %, preferably at least 24 wt %; preferably no more than 45 wt %, preferably no more than 40 wt %, preferably no more than 35 wt %, preferably no more than 30 wt %.

The detergent compositions of this invention are generally composed of a mixture of surfactants. At least one of the surfactants is an anionic surfactant. The anionic surfactants are preferably sulfates or sulfonates. One preferred anionic surfactant is an alkylbenzenesulfonate salt, represented by the formula R_{b}—C₆H₄—SO₃M, in which R_{b} represents a C₆-C₁₈ alkyl group, preferably linear, C₆H₄ represents a benzenediyl group, preferably a 1,4-benzenediyl group, and M represents a sodium, potassium, or ammonium ion. Another preferred anionic surfactant is the salt of the half-ester of an optionally ethoxylated fatty alcohol, of the formula Rₐ—O-(AO)ₙ—OSO₃M, where Rₐ represents a C₆-C₂₂ linear or branched alkyl group, AO represents ethylene oxide, propylene oxide, butylene oxide, or a combination of two or more alkylene oxides arranged randomly or in blocks, n is a number ranging from 0 to 10, and M represents a cation, preferably a sodium, potassium, or ammonium ion. Another preferred anionic surfactant is an alkyl sulfate salt, represented by the formula R_{c}—OSO₃M, in which R_{c} represents a C₆-C₁₈ alkyl group, preferably linear, and M represents a cation, preferably a sodium, potassium, or ammonium ion

The detergent may also contain a non-ionic surfactant, preferably a linear alcohol ethoxylate, in which the alcohol is a linear fatty alcohol of 6-22 carbons, and the surfactant contains 2 to 20 molar equivalents of ethylene oxide.

Preferably, the slurry comprises from 5 to 50 wt % total surfactant; preferably at least 10 wt %, preferably at least 15 wt %, preferably at least 20 wt %, preferably at least 25 wt %; preferably no more than 45 wt %, preferably no more than 40 wt %, preferably no more than 35 wt %. Preferably, the surfactant is an anionic surfactant.

Preferably, a polymer of this invention comprises no more than 0.3 wt % polymerized units of crosslinking monomers, preferably no more than 0.1 wt %, preferably no more than 0.05 wt %, preferably no more than 0.03 wt %, preferably no more than 0.01 wt %. A crosslinking monomer is a multiethylenically unsaturated monomer.

Preferably, the amount of polymerized AMPS units (including metal or ammonium salts) in a polymer of this invention is no more than 10 wt %, preferably no more than 5 wt %, preferably no more than 2 wt %, preferably no more than 1 wt %. Preferably, a polymer of this invention contains no more than 8 wt % polymerized units of esters of acrylic or methacrylic acid, preferably no more than 5 wt %, preferably no more than 3 wt %, preferably no more than 1 wt %.

Preferably, the polymer has M_{w} of at least 5,000, preferably at least 6,000, preferably at least 9,000, preferably at least 10,000, preferably at least 11,000, preferably at least 12,000; preferably no more than 70,000, preferably no more than 50,000, preferably no more than 30,000, preferably no more than 20,000, preferably no more than 15,000, preferably no more than 12,000.

The polymer may be used in combination with other polymers useful for controlling insoluble deposits in automatic dishwashers, including, e.g, polymers comprising combinations of residues of acrylic acid, methacrylic acid, maleic acid or other diacid monomers, esters of acrylic or methacrylic acid including polyethylene glycol esters, styrene monomers, AMPS and other sulfonated monomers, and substituted acrylamides or methacrylamides.

Preferably, the polymer of this invention is produced by solution polymerization. Preferably, the polymer is a random copolymer. Preferred solvents include 2-propanol, ethanol, water, and mixtures thereof. Preferably, the initiator does not contain phosphorus. Preferably, the polymer contains less than 1 wt % phosphorus, preferably less than 0.5 wt %, preferably less than 0.1 wt %, preferably the polymer contains no phosphorus. Preferably, polymerization is initiated with persulfate and the end group on the polymer is a sulfate or sulfonate. The polymer may be in the form of a water-soluble solution polymer, slurry, dried powder, or granules or other solid forms.

The polymers of the current invention are potentially useful as dispersants for other cleaning and water-treatment applications, including detergents used in automatic dishwashing in household and institutional washers.

Preferably, the composition has a pH of at least 10, preferably at least 11.5; in some embodiments the pH is no greater than 13.

Preferably, the slurry is spray dried at with hot air entering at a temperature from 150 to 500° C.; preferably from 250 to 500° C., preferably from 350 to 450° C.; and velocity of 0.1 to 3 m/s; preferably from 0.2 to 2 m/s, preferably from 0.3 to 1.5 m/s.

### EXAMPLES

Materials. The following materials are evaluated in the examples. Composition details are provided in Table 1.

ACUSOL™ 445N (comparative): a homopolymer of acrylic acid, available from The Dow Chemical Company.

ACUSOL™ 479N (comparative): a copolymer of acrylic acid, available from The Dow Chemical Company.

### Examples 1-5 (Inventive)

copolymers of acrylic acid and 2-(dimethylamino)ethyl methacrylate.

### Example 6 (Comparative)

a copolymer of acrylic acid and 2-(dimethylamino)ethyl methacrylate.

### Examples 7-9 (Inventive)

copolymers of acrylic acid and N-[3-(dimethylamino)propyl]methacrylamide.

TABLE 1

| | Composition | | | | |
|---|---|---|---|---|---|
| | Monomer 1 | | Monomer 2 | | M_{w} |
| Polymer | ID | wt % | ID | wt % | (Da) |
| ACUSOL ™ 445N | AA | 100 | | | 7800 |
| Example 1 | AA | 95 | DMAEMA | 5 | 20783 |
| Example 2 | AA | 90 | DMAEMA | 10 | 20395 |
| Example 3 | AA | 80 | DMAEMA | 20 | 19921 |
| Example 4 | AA | 60 | DMAEMA | 40 | 19480 |
| Example 5 | AA | 90 | DMAEMA | 10 | 7209 |
| Example 6 | AA | 50 | DMAEMA | 50 | 19235 |
| Example 7 | AA | 90 | DMAPMA | 10 | 9569 |
| Example 8 | AA | 90 | DMAPMA | 10 | 18098 |
| Example 9 | AA | 90 | DMAPMA | 10 | 39150 |

AA = acrylic acid, DMAEMA = 2-(dimethylamino)ethyl methacrylate, DMAPMA = N-[3-(dimethylamino)propyl]methacrylamide

### Polymer Synthesis

### Example 1

To a two liter round bottom flask equipped with a mechanical stirrer, heating mantle, thermocouple, condenser, Nitrogen inlet and inlets for the addition of cofeeds, was charged 300 g deionized water. A promoter solution of 3.32 g of 0.15% iron sulfate heptahydrate was prepared and set aside. A kettle additive of 0.63 g sodium metabisulfite dissolved in 10.0 g of deionized water was prepared and set aside. The kettle contents were stirred and heated to 73±1° C. with a nitrogen sweep. At the same time, 380 g of glacial acrylic acid (AA) was added to a graduated cylinder for addition to the kettle. Separately, 20 g of 2-(dimethylamino)ethyl methacrylate (DMAEMA) was added to a syringe for addition to the kettle. An initiator solution of 1.15 g of sodium persulfate dissolved in 50.0 g deionized water was added to a syringe for addition to the kettle. A chain regulator solution of 13.37 g of sodium metabisulfite dissolved in 60.0 g of deionized water was added to a syringe for addition to the kettle.

When the kettle contents reached the reaction temperature of 73° C., the promoter solution and sodium metabisuflte kettle additive charges were added to the kettle. Upon return to reaction temperature, the monomers, initiator, and chain regulator cofeeds were started simultaneously and separately. The chain regulator solution was added over 80 minutes, monomer cofeeds was added over 90 minutes and the initator cofeed was added over 95 minutes at 73±1° C. Two chaser solutions of 0.53 g of sodium persulfate dissolved in 10.0 g of deionized water were prepared and added to separate syringes. The first chaser solution was added 10 minutes after the completion of the initiator cofeed. The first chaster solution was added to the kettle over 10 minutes, then held for 20 minutes. After this hold was completed, the second chaser solution was added over 10 minutes, then held for an additional 20 minutes.

While cooling the reactor using a stream of air, 175.0 g of 50% sodium hydroxide was added to the kettle via addition funnel at a rate such that the reaction temperature was maintained below 60° C. Hydrogen peroxide (1.2 g of a 35% solution) was added to the kettle as a scavenger. After 10 minutes, 151.3 g of 50% sodium hydroxide was added to the kettle via addition funnel at a rate such that the reaction temperature was maintained below 60° C. Deionized water (60.0 g) was added to the funnel as a final rinse. The contents were then cooled and packaged.

The final product had a solids content of 42.21%, pH of 6.27, viscosity of 1480 cP. Residual AA content was 70 ppmw. The weight- and number-average molecular weights were 20783 and 5583 g/mol, respectively.

Examples 2-6 may be prepared by a person skilled in the art substantially as described above for Example 1, with appropriate modifications to reagents and conditions.

### Example 7

To a two liter round bottom flask equipped with a mechanical stirrer, heating mantle, thermocouple, condenser, Nitrogen inlet and inlets for the addition of cofeeds, was charged 300 g deionized water and 3.32 g of 0.15% iron sulfate heptahydrate. A kettle additive of 0.4 g sodium metabisulfite dissolved in 7.0 g of deionized water was prepared and set aside. The kettle contents were stirred and heated to 73±1° C. with a nitrogen sweep. At the same time, 360 g of glacial AA was added to a graduated cylinder for addition to the ketlle. Separately, 40 g of N-[3-(dimethylamino)propyl]methacrylamide (DMAPMA) was added to a syringe for addition to the kettle. An initiator solution of 1.25 g of sodium persulfate dissolved in 50.0 g deionized water was added to a syringe for addition to the kettle. A chain regulator solution of 8.6 g of sodium metabisulfite dissolved in 70.0 g of deionized water was added to a syringe for addition to the kettle.

When the kettle contents reached the reaction temperature of 73° C., the sodium metabisuflte kettle additive charge was added to the kettle. Upon return to reaction temperature, the monomers, initiator, and chain regulator cofeeds were started simultaneously and separately. The chain regulator solution was added over 80 minutes, monomer cofeeds was added over 90 minutes and the initator cofeed was added over 95 minutes at 73±1° C. Two chaser solutions of 0.53 g of sodium persulfate dissolved in 10.0 g of deionized water were prepared and added to separate syringes. The first chaser solution was added 10 minutes after the completion of the initiator cofeed. The first chaster solution was added to the kettle over 5 minutes, then held for 10 minutes. After this hold was completed, the second chaser solution was added over 5 minutes, then held for an additional 10 minutes.

While cooling the reactor using a stream of air, 100 g of 50% sodium hydroxide was added to the kettle via addition funnel at a rate such that the reaction temperature was maintained below 60° C. Hydrogen peroxide (1.0 g of a 35% solution) was added to the kettle as a scavenger. After 10 minutes, 202 g of 50% sodium hydroxide was added to the kettle via addition funnel at a rate such that the reaction temperature was maintained below 60° C. Deionized water (90.0 g) was added to the funnel as a final rinse. The contents were then cooled and packaged.

The final product had a solids content of 41.22%, pH of 6.52, viscosity of 2880 cP. Residual AA content was 23 ppmw. The weight- and number-average molecular weights were 39150 and 8527 g/mol, respectively.

Examples 8 and 9 may be prepared by a person skilled in the art substantially as described above for Example 7, with appropriate modifications to reagents and conditions.

Polymer Molecular Weight. Molecular weight may be measured by gel permeation chromatograph (GPC) using known methodology, for instance with the following typical parameters:

### Analytical Parameters:

Instrument: Agilent 1100 HPLC system with isocratic pump, vacuum degasser, variable injection size autosampler, and column heater, or equivalent.
Detector: Agilent 1100 HPLC G1362A Refractive Index detector, or equivalent.
Software: Agilent ChemStation, version B.04.03 with Agilent GPC-Addon version B.01.01.
Column Set: TOSOH Bioscience TSKgel G2500PWxl7.8 mm ID×30 cm, 7 μm column (P/N 08020) with TOSOH Bioscience TSKgel GMPWxl7.8 mm ID×30 cm, 13 μm (P/N 08025).

### Method Parameters:

Mobile Phase: 20 mM Phosphate buffer in MilliQ HPLC Water, pH ˜7.0.
Flow Rate: 1.0 ml/minute
Injection volume: 20 μL
Column temperature: 35° C.
Run time: 30 minutes

### Standards and Samples:

Standards: Polyacrylic acid, Na salts Mp 216 to Mp 1,100,000. Mp 900 to Mp 1,100,000 standards from American Polymer Standards.
Calibration: Polynomial fit using Agilent GPC-Addon software (Polynomial 4 used).
Injection concentration: 1-2 mg solids/mL 20 mM GPC mobile phase diluent. Used for both standards and samples.
Sample concentration: Typically, 10 mg sample into 5 mL 20 mM AQGPC mobile phase solution.
Flow Marker: 30 mM phosphate

### Solutions Preparation:

Mobile Phase: Mobile Phase: Weigh out 14.52 g sodium phosphate monobasic (NaH₂PO₄) and 14.08 g sodium phosphate dibasic (Na₂HPO₄). Dissolve into 11 L MilliQ HPLC water, stir to fully dissolve all solids. After dissolution is complete, adjust the solution to pH 7 with 0.5 N sodium hydroxide. This solution is used for mobile phase and sample/standard preparation via a fixed volume repipetor.
Flow Marker: Mix, by weight, equal amounts of solid Na₂HPO₄ and NaH₂PO₄. Using the well-blended mix, weigh 1.3 grams and dissolve into 1 liter of the 20 mM AQGPC mobile phase mix.

### Example 10

A representative crutcher slurry used in commercial powder detergent manufacture was simulated in the lab with the following ingredients (Table 2).

TABLE 2
Detergent Slurry composition with sodium sulfate increase

| | ACUSOL ™ | | | |
|---|---|---|---|---|
| | 479N | ACUSOL ™ | | |
| | 35% water | 479N | Example 2 | Example 5 |
| Ingredients | (Control) | 25% water | 25% water | 25% water |
| Water | 20.80% | 10.80% | 10.80% | 10.80% |
| NaOH 50% | 5.20% | 5.20% | 5.20% | 5.20% |
| Sulfonic acid | 25% | 25% | 25% | 25% |
| (LAS 96) | | | | |
| Dispersant** | 3% | 3% | 3% | 3% |
| Sodium Sili- | 18% | 18% | 18% | 18% |
| cate (53%) | | | | |
| Carboxy | 1.50% | 1.50% | 1.50% | 1.50% |
| Methyl Cellu- | | | | |
| lose (Walocel | | | | |
| CRT 100) | | | | |
| Sodium | 14% | 31.50% | 31.50% | 31.50% |
| Sulfate | | | | |
| Sodium | 12.50% | 5% | 5% | 5% |
| Carbonate | | | | |
| Slurry | 1,140,000 | Can't be | 4,450,000 | 3,340,000 |
| Viscosity (cP) | | measured | | |
| Viscosity | 40° C., | 40° C., | 40° C., | 40° C., |
| condition | 2 RPM, | 2 RPM, | 2 RPM, | 2 RPM, |
| | T-F spindle | T-F spindle | T-F spindle | T-F spindle |

### Experimental Polymers Produced by Process Used for Materials Referenced in Table 1

The ingredients were added in the order shown in Table 2 using a lab multi propeller mixer. The polymer compositions evaluated in the experiment are referenced as Dispersant in Table 2. The slurry viscosity of formulations prepared using polymer compositions claimed in this invention (Table 1) are compared with the slurry viscosity of ACUSOL™ 479N (dispersant polymer used in current formulations). The viscosity was measured at 40° C. by Brookfield viscometer using T-F spindle at 2 rpm. The measured viscosity of ACUSOL™ 479N and the experimental polymers at same dosage when water content in the slurry is reduced from 35% to 25% are shown in Table 2. The water reduction is compensated by increasing sodium sulfate and reducing sodium carbonate in low water formulations. In this example for a 10% water reduction in slurry, polymer composition of Example 2 and 5 increase in viscosity but still continue to show flow behavior. On the contrary, 25% water ACUSOL™ 479N slurry became a thick paste whose viscosity could not be measured.

### Example 11

A crutcher slurry composition used in commercial powder detergent manufacture was prepared in the lab using ingredients shown in Table 3 below. The ingredients were added in the order shown in Table 3 using a lab multi propeller mixer. The polymer compositions evaluated in the experiment are referenced as Dispersant in Table 3. The slurry viscosity of formulations prepared using polymer compositions (Table 1) claimed in this invention are compared with the slurry viscosity of the ACUSOL™ 479N (i.e. the dispersant polymer used in current formulations). The viscosity was measured at 40° C. by Brookfield viscometer using T-F spindle at 1 and 2 rpm. The measured viscosity for ACUSOL™ 479N and the experimental polymers at the same dosage when water in the slurry is reduced from 35% to 25% are shown in Table 3. The water reduction is compensated by a proportional increase in all other ingredients for low water formulations. In this example, for a 10% reduction in water, the polymer composition of Example 5 increases in viscosity but is still flowable. However, the 25% water slurries for both Example 2 and ACUSOL™ 479N turned into a thick paste whose viscosity could not be measured.

TABLE 3
Detergent Slurry composition with proportional
increase in all ingredients

| | ACUSOL ™ | | | |
|---|---|---|---|---|
| | 479N | ACUSOL ™ | | |
| | 35% water | 479N | Example 2 | Example 5 |
| Ingredients | (Control) | 25% water | 25% water | 25% water |
| Water | 20.80% | 9.40% | 9.40% | 9.40% |
| NaOH 50% | 5.20% | 6.00% | 6.00% | 6.00% |
| Sulfonic acid | 25% | 28.7% | 28.7% | 28.7% |
| (LAS 96*) | | | | |
| Dispersant** | 3% | 3% | 3% | 3% |
| Sodium Sili- | 18% | 20.7% | 20.7% | 20.7% |
| cate (53%) | | | | |
| Carboxy | 1.50% | 1.70% | 1.70% | 1.70% |
| Methyl Cellu- | | | | |
| lose (Walocel | | | | |
| CRT 100) | | | | |
| Sodium | 14% | 16.10% | 16.10% | 16.10% |
| Sulfate | | | | |
| Sodium | 12.50% | 14.4% | 14.4% | 14.4% |
| Carbonate | | | | |
| Slurry | 1,140,000 | Can't be | Can't be | 5,320,000 |
| Viscosity (cP) | | measured | measured | |
| Viscosity | 40° C., | 40° C., | 40° C., | 40° C., |
| condition | 2 RPM, | 2 RPM, | 2 RPM, | 1 RPM, |
| | T-F spindle | T-F spindle | T-F spindle | T-F spindle |

### Experimental Polymers Produced by Process Used for Materials Referenced in Table 1

### Example 12

A crutcher slurry composition used in commercial powder detergent manufacture was prepared in the lab using ingredients shown in Table 4 below. The ingredients were added in the order shown using a lab multi propeller mixer. The polymer compositions evaluated in the experiment are referred as Dispersant in Table 4. The slurry viscosity of formulations prepared using Example 2 (Table 1) is compared with the slurry viscosity of ACUSOL™ 445N (another dispersant polymer used in current formulations). The viscosity was measured at 40° C. by Brookfield viscometer using HB-4 spindle 10 rpm. The measured viscosity for ACUSOL™ 445N and the experimental polymers when water in the slurry is reduced from 30% to 25% at two different dosages (0.5 and 1.5%) are shown in Table 4. The water reduction is compensated by increasing sodium sulfate in the formulation.

TABLE 4
Dose response for slurry viscosity reduction

| | ACUSOL ™ | | | | |
|---|---|---|---|---|---|
| | 445N | ACUSOL ™ | ACUSOL ™ | | |
| | 30% water | 445N | 445N | Example 2 | Example 2 |
| Ingredients | (Control) | 25% water | 25% water | 25% water | 25% water |
| Water | 17.5% | 13.35% | 12.50% | 13.35% | 12.50% |
| NaOH 50% | 2.5% | 2.5% | 2.5% | 2.5% | 2.5% |
| Sulfonic acid | 12.0% | 12.0% | 12.0% | 12.0% | 12.0% |
| (LAS 96*) | | | | | |
| Dispersant** | 1.5% | 0.5% | 1.5% | 0.5% | 1.5% |
| Sodium Sili- | 21.5% | 21.5% | 21.5% | 21.5% | 21.5% |
| cate (53%) | | | | | |
| Nonionic | 1.3% | 1.3% | 1.3% | 1.3% | 1.3% |
| surfactant | | | | | |
| (Biosoft | | | | | |
| N25-7) | | | | | |
| Sodium | 38.4% | 43.55% | 43.40% | 43.55% | 43.40% |
| Sulfate | | | | | |
| Sodium | 5.3% | 5.3% | 5.3% | 5.3% | 5.3% |
| Carbonate | | | | | |
| Slurry | 11,680 | 160,000 | 44,000 | 36,800 | 32,320 |
| Viscosity (cP) | | | | | |
| Viscosity | 40° C., | 40° C., | 40° C., | 40° C., | 40° C., |
| condition | 10 RPM, | 10 RPM, | 10 RPM, | 10 RPM, | 10 RPM, |
| | HB-4 spindle | HB-4 spindle | HB-4 spindle | HB-4 spindle | HB-4 spindle |

### Experimental Polymers Produced by Process Used for Materials Referenced in Table 1

For a 5% reduction in water, the polymer composition of Example 2 at 0.5% dosage achieves the lowest viscosity (closest to ACUSOL™ 445N control slurry containing 30% water) and has lower viscosity than ACUSOL™ 445N at 1.5% dosage. At the same dosage (0.5%) the ACUSOL™ 445N containing slurry is −4 times more viscous than the slurry containing Example 2.

The performance of detergent is dependent on the quality of final dried powder, which is attributed to the flowability, friability, shape, bulk density, dispersion, and composition uniformity. Bulk density is important to consumer as the final product is measured by volume into the washing machine. Control of density is also important to the manufacturer as it impacts the cost of packaging and transportation. It is expected that a lower viscosity at same solids percentage effected due to the claimed polymer compositions would improve morphology of the spray dried particle and will eventually result into improved bulk transport and storage properties.

During spray drying the evaporation of a solution droplet is controlled by two counteracting mechanisms. First is the recession of the droplet surface due to solvent evaporation, wherein the droplet diameter decreases with drying time on account of solvent evaporation. This promotes higher surface concentration by sweeping away solvent molecules. The second is the diffusion of the solutes from the droplet surface towards its lower concentration core. When the diffusion of solute particles towards the core is faster than the rate of recession of droplet surface due to evaporation—it results in the formation of a solid, uniform and dense particle. On the other hand, when the droplet surface recession is faster than solute diffusion to core, it promotes a higher surface concentration of the solutes thus forming a shell, thereby causing the particle to be porous and therefore low density (see M. A. Boraey, R. Vehring, ‘Diffusion controlled formation of microparticles’, Journal of Aerosol Science 67 (2014) 131-143). Since solute diffusivity varies inversely with viscosity, the claimed polymer process additive due to its viscosity reduction effect at a given solids percentage will result in the formation of smaller diameter and higher bulk density detergent granule.

Chemical composition uniformity is not only important for product performance, but also for process performance and safety, so that there is no variation or separation of slurry ingredients during spray drying. The slurry is a mixture of free water with dissolved solids, suspended solids and inorganic crystal hydrates, as well as water associated with crystal structures of the organic surfactants. During drying not only the “free” water but also water from some of the crystal hydrates present is removed, resulting in surface enrichment of the evaporating droplet. A lower slurry viscosity during spray drying will also slow down droplet surface enrichment and increase the shell formation time thus resulting in a more uniform distribution of the detergent components (see Vehring, et. al., ‘Particle formation in spray drying’, Journal of Aerosol Science 38 (2007) 728-746).

Alternately, as demonstrated in examples the claimed polymer compositions will enable a decrease in water percentage (or increase in solids percentage) in the slurry without a dramatic increase in viscosity. During spray drying the size of granule increases as a result of “puffing” due to water evaporation. A reduced water content in the slurry reduces this effect and will result into small diameter granule, with high density and less porosity. A reduced slurry water content will also increase plant throughput and reduce unit energy consumption during spray drying.

1. A method for producing a powder detergent; said method comprising steps of:
(a) combining (i) a polymer comprising polymerized units of at least one nitrogen-containing ethylenically unsaturated monomer having at least one pKa value from 6 to 11.5 and at least one ethylenically unsaturated carboxylic acid monomer, (ii) at least one surfactant, (iii) inorganic salts and (iv) water to form a slurry; wherein the slurry has a solids content from 50 to 90 wt %; and (b) spray drying the slurry to form a powder detergent.

2. The method of claim 1 in which the polymer comprises polymerized units of from 5 to 40 wt % of at least one ethylenically unsaturated monomer comprising a tertiary amino group and from 60 to 95 wt % of at least one C₃-C₈ ethylenically unsaturated carboxylic acid monomer.

3. The method of claim 2 in which the nitrogen-containing ethylenically unsaturated monomer comprises a dialkylaminoalkyl group.

4. The method of claim 3 in which the slurry has a solids content from 55 to 85 wt %.

5. The method of claim 4 in which the polymer comprises polymerized units of from 5 to 30 wt % of at least one (meth)acrylic acid ester or amide having a C₄-C₁₅ aminoalkyl group and from 60 to 95 wt % of at least one (meth)acrylic acid.

6. The method of claim 5 in which the polymer has M_{w} from 5,000 to 50,000.

7. The method of claim 6 in which the polymer comprises polymerized units of from 7 to 30 wt % of at least one di-(C₁-C₄ alkyl)aminoethyl or di-(C₁-C₄ alkyl)aminopropyl (meth)acrylate or (meth)acrylamide and from 70 to 93 wt % of at least one (meth)acrylic acid.

8. The method of claim 7 in which the slurry is spray dried at with hot air entering at a temperature from 150 to 500° C. and velocity of 0.1 to 3 m/s.

9. The method of claim 8 in which the di-(C₁-C₄ alkyl)aminoethyl or di-(C₁-C₄ alkyl)aminopropyl (meth)acrylate or (meth)acrylamide is 2-(dimethylamino)ethyl methacrylate or N-[3-(dimethylamino)propyl]methacrylamide.
